(19) United States
(12) Patent Application Publication
(10) Pub. No.: US 2013/0289991 A1
(43) Pub. Date: Oct. 31, 2013

(54) Application of Voice Tags in a Social Media Context

(71) Applicants: Bhavani K. Eshwar, Karnataka (IN); Martin A. Oberhofer, Bondorf (DE); Sushain Pandit, Austin, TX (US)

(72) Inventors: Bhavani K. Eshwar, Karnataka (IN); Martin A. Oberhofer, Bondorf (DE); Sushain Pandit, Austin, TX (US)

(73) Assignee: INTERNATIONAL BUSINESS MACHINES CORPORATION, Armonk, NY (US)

(21) Appl. No.: 13/459,633

(22) Filed: Apr. 30, 2012

(51) Int. Cl. G10L 17/00

(52) U.S. Cl. 704/246; 704/E17.003

(57) ABSTRACT

According to a present invention embodiment, a system utilizes a voice tag to automatically tag one or more entities within a social media environment, and comprises a computer system including at least one processor. The system analyzes the voice tag to identify one or more entities, where the voice tag includes voice signals providing information pertaining to one or more entities. One or more characteristics of each identified entity are determined based on the information within the voice tag. One or more entities appropriate for tagging within the social media environment are determined based on the characteristics and user settings within the social media environment of the identified entities, and automatically tagged. Embodiments of the present invention further include a method and computer program product for utilizing a voice tag to automatically tag one or more entities within a social media environment in substantially the same manner described above.

### BACKGROUND

1. Technical Field

Present invention embodiments relate to voice tags, and more specifically, to tagging entities (e.g., persons, animals, objects, any item in a social network that can be associated with a voice tag, etc.) within images for social media environments based on voice tags.

2. Discussion of the Related Art

Images may be tagged for various purposes. For example, voice tagging methodologies (e.g., associated with digital cameras, mobile devices, etc.) enable a user to record a voice tag for a particular image and associate the voice tag with that image. The voice tag is subsequently used to retrieve the image based on a voice input utilized for indexing the images (e.g., via a speech-to-text conversion device).

Further, persons within an image may be tagged to indicate the presence of those persons within the image. This is typically utilized for social media environments. These types of tags are textual and may be entered manually by users within the social media environments. In addition, automatic tagging of persons in images may be performed by facial recognition mechanisms. However, the automatic tagging of persons raises several issues pertaining to privacy, ownership of the image, and rights of users to tag people in the images.

### BRIEF SUMMARY

According to one embodiment of the present invention, a system utilizes a voice tag to automatically tag one or more entities associated with a data object within a social media environment, and comprises a computer system including at least one processor. The system analyzes the voice tag to identify one or more entities recited in the voice tag. The voice tag includes voice signals providing information pertaining to one or more entities associated with a data object. One or more characteristics of each identified entity are determined based on the information within the voice tag. One or more entities appropriate for tagging within the social media environment are determined based on the one or more characteristics and user settings within the social media environment of the identified entities. The determined one or more entities are automatically tagged within the social media environment. Embodiments of the present invention further include a method and computer program product for utilizing a voice tag to automatically tag one or more entities within a social media environment in substantially the same manner described above.

### BRIEF DESCRIPTION OF THE SEVERAL VIEWS OF THE DRAWINGS

FIG. 1 is a diagrammatic illustration of an example computing environment for use with an embodiment of the present invention.

FIGS. 2A-2B are a procedural flow chart illustrating a manner in which a voice tag is utilized to tag entities within an associated image according to an embodiment of the present invention.

FIG. 3 is a procedural flow chart illustrating a manner in which a sentiment is determined for an entity within a voice tag according to an embodiment of the present invention.

FIG. 4 is a procedural flow chart illustrating a manner in which a sensitivity index is determined for an entity within a voice tag according to an embodiment of the present invention.

FIG. 5 is a procedural flow chart illustrating a manner in which a graphical representation of relationships between entities is determined according to an embodiment of the present invention.

FIG. 6 is an illustration of an example graphical representation of relationships between entities.

### DETAILED DESCRIPTION

Present invention embodiments enable a user to easily associate a voice tag with an image, and intelligently process the voice tag to determine the entities within the image appropriate for tagging within a social media environment. The voice tag includes voice and/or speech signals entered by the user pertaining to entities (e.g., persons, animals, objects, etc.) and/or characteristics associated with the image. The determination of the entities to tag is based on a combination of criteria, including a relationship graph of a user capturing and/or uploading the image into the social media environment, sentiments expressed in the voice tag for the image, popularity of the entities in the voice tag (e.g., based on external sources), and explicit privacy settings from the social media environment of the entities within the voice tag.

Present invention embodiments provide definitions of XML-based metadata covering voice-related attributes of a voice tag for an image or video, and analytic results of voice tags. Further, extensions to software of image capture devices (e.g., digital cameras, smartphones, etc.) are provided to improve voice tag capture, while extensions for relational databases enable capturing and processing voice tag information for images. In addition, a new data structure or type with built-in functions is employed for storing images and corresponding voice tags.

Present invention embodiments provide several advantages. In particular, voice tags are utilized in a social media context, where entities within shared voice tagged images are automatically tagged. Voice tags are captured at, or proximate, the time of image capture, and are appropriately embedded in images, thereby preventing loss and simplifying management of the voice tags. The voice tags are further accessible for data mining/text analytics. Moreover, voice tags are language-dependent, but managed in a language-oriented manner, and may be cross-linked in Enterprise Content Management (ECM) environments.

A set of optimized approaches are provided to consume voice tagged image data and allied business requirements. Further, search capabilities and corresponding results for images are improved using metadata, where the meaning of result lists are enhanced with a faceted search. Thus, present invention embodiments provide enhanced tooling to work with voice tagged images.

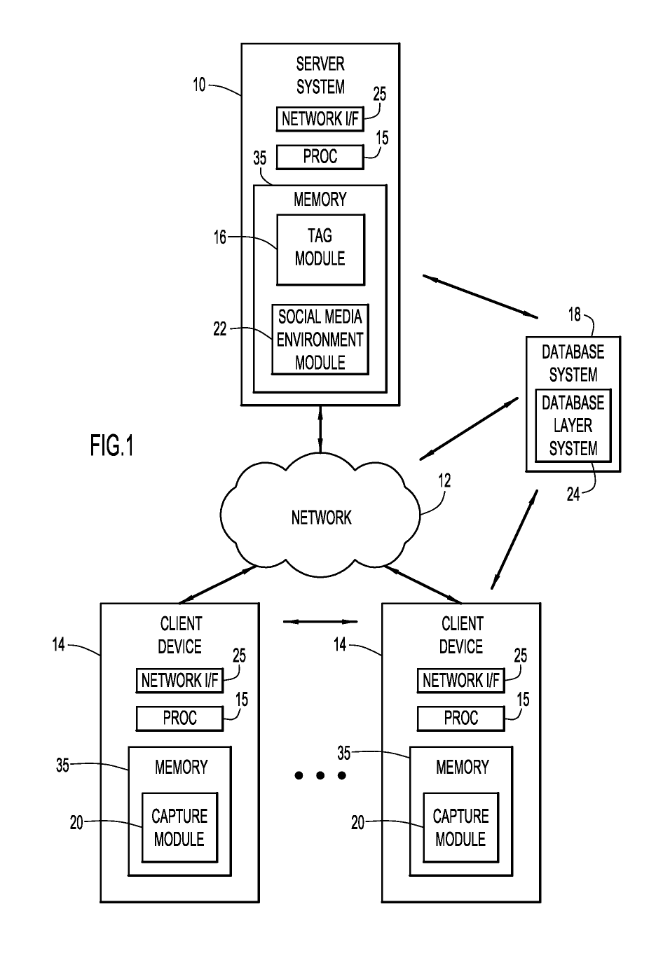

An example environment for use with present invention embodiments is illustrated in FIG. 1. Specifically, the environment includes one or more server systems 10 and one or more client or end-user devices 14. Server systems 10 and client devices 14 may be remote from each other and communicate over a network 12. The network may be implemented by any number of any suitable communications media (e.g., wide area network (WAN), local area network (LAN), Internet, Intranet, etc.). Alternatively, server systems 10 and client devices 14 may be local to each other, and communicate via any appropriate local communication medium (e.g., local area network (LAN), hardwire, wireless link, Intranet, etc.).

Client devices 14 capture and/or provide images with voice tags to server systems 10 to determine entities (e.g., persons, animals, objects, etc.) within the voice tags appropriate for tagging within the images. The client devices include a capture module 20 to embed the voice tag with the image as described below. The server systems include a tag module 16 to tag the entities of images within the voice tags for a social media environment in response to satisfaction of various criteria, and a social media environment module 22 to provide the social media environment. The tag module may be incorporated into, or be external of, the social media environment to process the voice tags. A database system 18 may store various information for the analysis (e.g., user profiles and settings, sensitivity, polarity, etc.). The database system may be implemented by any conventional or other database or storage unit, may be local to or remote from server systems 10 and client devices 14, and may communicate via any appropriate communication medium (e.g., local area network (LAN), wide area network (WAN), Internet, hardwire, wireless link, Intranet, etc.).

The client devices may present a graphical user (e.g., GUI, etc.) or other interface (e.g., command line prompts, menu screens, etc.) to solicit information from and provide information to users pertaining to the desired images and analysis.

Server systems 10 and client devices 14 may be implemented by any conventional or other computer systems preferably equipped with a display or monitor, a base (e.g., including at least one processor 15, one or more memories 35 and/or internal or external network interfaces or communications devices 25 (e.g., modem, network cards, etc.)), optional input devices (e.g., a keyboard, mouse or other input device), and any commercially available and custom software (e.g., server/communications software, social media environment module, tag module, capture module, browser/interface software, etc.).

Client devices 14 may alternatively be in the form of a hand-held or mobile device (e.g., smart or other mobile telephone, personal digital assistant, tablet, etc.) capable of capturing images and voice tags. The hand-held or mobile client devices are preferably equipped with a display or monitor, a base (e.g., including at least one processor 15, one or more memories 35 and/or internal or external network interfaces or communications devices 25 (e.g., wireless, etc.)), optional input devices (e.g., a keyboard, touch screen, or other input device), and any commercially available and custom software (e.g., communications software, capture module, browser/interface software, applications, etc.).

Images and voice tags may be captured by the hand-held or mobile client device and provided to server system 10 directly from that client device via network 12. In this case, the hand-held or mobile client device (e.g., via capture module 20) may embed the voice tag within the image data. Alternatively, the hand-held or mobile client device may transfer the captured image and voice tag to another client device (e.g., in the form of a computer system) for transference to the server system via network 12. In this case, the hand-held or mobile client device (e.g., via capture module 20) may embed the voice tag within the image data and transfer the information to the client computer system for transference to server system 10, or provide the image data and voice tag as separate data sets where the client computer system (e.g., via capture module 20) embeds the voice tag within the image data for transference to server system 10. The client computer system may similarly capture an image and corresponding voice tag and (e.g., via capture module 20) embed the voice tag within the image for transference to server system 10.

Tag module 16, capture module 20, and social media environment module 22 may include one or more modules or units to perform the various functions of present invention embodiments described below. The various modules (e.g., tag module, capture module, social media environment module, etc.) may be implemented by any combination of any quantity of software and/or hardware modules or units, and may reside within memory 35 of the server and/or client devices for execution by processor 15.

Present invention embodiments are preferably utilized with devices that enable recording of a voice tag for a corresponding image at, or proximate, the time the image is captured (e.g., personal computer, digital cameras with voice-input options, smartphones with a digital camera and a microphone input option, devices for various scenarios where voice and image can be captured shortly after each other (e.g., a doctor recording a diagnosis while reviewing x-ray images, a screen shot being taken on a laptop or a desktop computer with an enabled microphone, etc.), etc.).

These devices include capture module 20 to enable image capture and voice tagging. With respect to digital cameras and other devices, the capture module may provide a start/stop function to record voice tags with a sequencing function, settings to capture the spoken language (if this is not set, enrichment may subsequently determine the natural language spoken), and simple analytics/preview capabilities (e.g., a doctor looking at a digital x-ray image may desire to view x-rays with a similar diagnosis prior to completing the voice tag for the x-ray and making final recommendations on diagnosis and treatment).

Capture module 20 may embed the voice tag within the image data. Several formats (e.g., EXIF, GIF, JPEG, etc.) enable XML to be embedded within an image. With respect to EXIF files, WAV audio files provide a structure for metadata on the audio. However, this is not generic for all different types of audio files, and lacks important elements (e.g., the name of the audio file, the language setting for the spoken language of the speaker, the sequence (if there are a plurality of audio files) related to an image, attributes storing information about enrichments, etc.). Present invention embodiments provide a data structure or type (referred to herein as “VTIMAGE”) that captures required attributes and enrichment information. The data structure includes image data, a corresponding voice tag, and XML metadata. The XML metadata includes attributes pertaining to the voice tag (e.g., name, place, etc.). The capture module generates the data structure (with the image, voice tag, and metadata), and provides or pushes this information to tag module 16 and a corresponding server system 10 for processing. Alternatively, the image and voice tag may be provided to the tag module as separate data sets for processing in order to determine entities for tagging.

The data structure may alternatively be generated from a captured image and voice tag, and stored in a database or repository (e.g., database system 18). In this case, the tag module and corresponding server may poll the database for new entries, and pull or retrieve the new images to process the voice tags for tagging of entities within the social media environment. Accordingly, present invention embodiments provide a modified database layer that enables improved performance for databases handling the data structure. The database layer includes a system 24 for database engines that preprocesses image files with embedded voice tags to partition the image section and the voice section in order to use the voice section for pre-processing the data structure. The database layer system includes a preprocessor (e.g., hardware and/or software modules) converting an input object with raw voice (e.g., voice tag) to text encoding for custom pre-processing, and an extensible preprocessor (e.g., hardware and/or software modules) with a default implementation of a voice-to-XML transcoder to convert the encoded voice tag text to XML structures.

The database layer system further provides regular indexing of a VTIMAGE column type in database engines using a single string or a phrase that may occur. This enables the image to be indexed based on text or a phrase from the voice tag. In addition, specific operators for voice tagging are provided in the database system (e.g., supporting Enterprise Content Management (ECM) solutions). This approach minimizes changes to applications since the required logic is built into the database.

Present invention embodiments process voice tags to determine the entities of an image within the voice tag appropriate for tagging within the social media environment. The entity and relationship knowledge expressed in the voice tag are combined with the sentiments with which a user has recorded the voice tag to determine whether or not an entity of the image within the voice tag should be tagged.

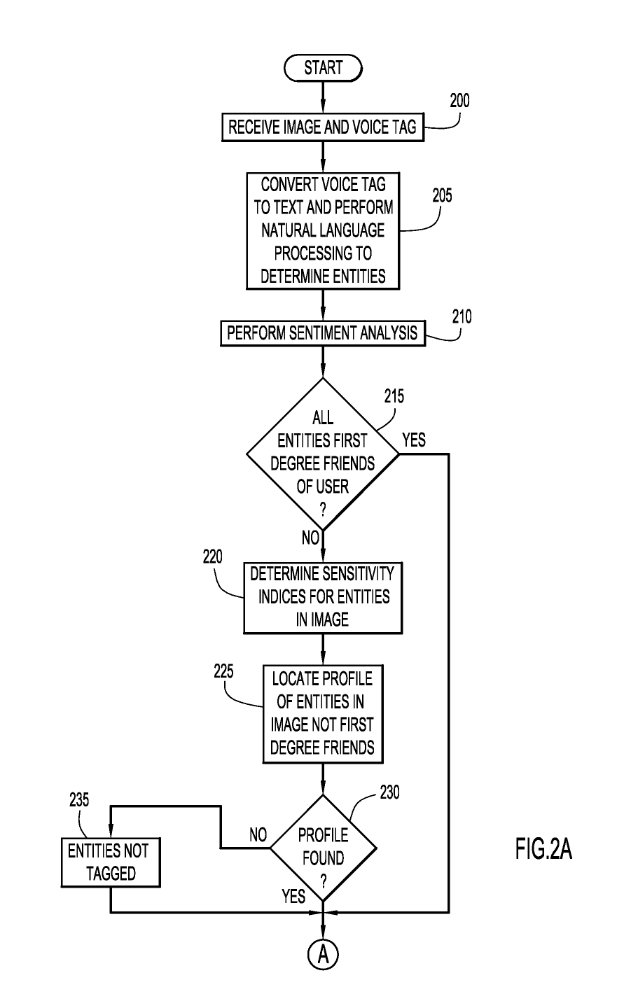

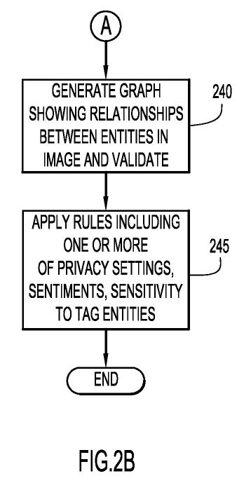

A manner in which a voice tag of an image is processed to determine tagging of one or more entities of the image within the voice tag (e.g., via tag module 16 and a corresponding server system 10) according to an embodiment of the present invention is illustrated in FIGS. 2A-2B. Initially, a user captures an image and records an associated voice tag using a client device 14 (e.g., via capture module 20 and processor 15 of that client device) at step 200. The image is transferred or pushed from the client device to server system 10 providing the social media environment (e.g., via social media environment module 22). Alternatively, the image may be stored in a repository, and retrieved or pulled by the server system as described above.

Once the image and voice tag are received at the server system, the voice tag is retrieved and converted to text at step 205. Natural language processing (NLP) techniques are applied to the converted text to determine entities within the voice tag and corresponding relationships. The conversion and natural language processing may be performed by various conventional or other techniques (e.g., Stanford CoreNLP, etc.).

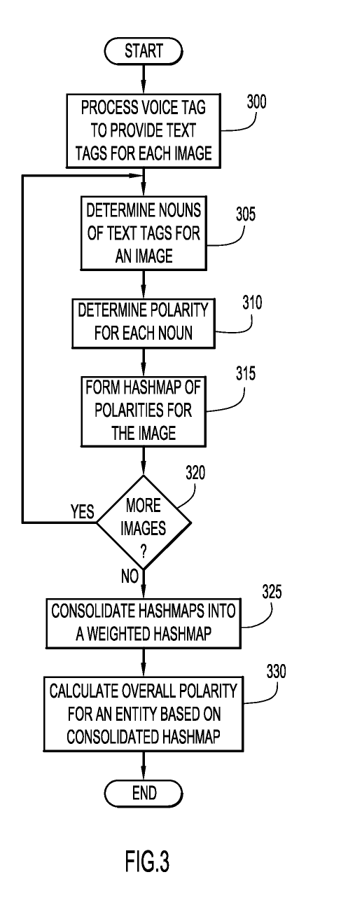

Sentiment analysis is subsequently performed on the converted text (typically representing a sentence) to determine a polarity or sentiment with respect to different entities expressed in the voice tag at step 210. The polarity is preferably represented as being positive, negative, or neutral with respect to an entity within the voice tag. This analysis is further described below with respect to FIG. 3.

The entities within the voice tag are compared to a friend graph of the user capturing and/or uploading the image at step 215. The friend graph is provided by the social media environment and indicates relationships between the user and other users within the social media environment. The graph typically includes a series of nodes representing users and connections or links indicating the relationship or association.

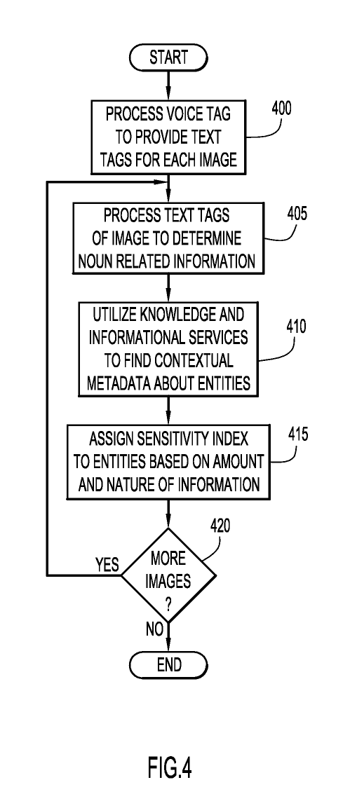

When all of the entities within the voice tag are not first degree friends of the user (e.g., not directly linked or more than one node away within the friend graph) as determined at step 215, an external search is performed to determine sensitivity indices for the entities within the voice tag at step 220. The sensitivity is based on a measure of popularity or notoriety of the entity as indicated by external sources. Generally, the greater the popularity or notoriety of the entity, the greater the sensitivity index and less likely the entity should be tagged within the social media environment. The sensitivity analysis is further described below with respect to FIG. 4.

Once the sensitivity indices are determined, the profile of entities that are not first degree friends of the user capturing and/or uploading the image are retrieved at step 225 for analysis as described below. If profiles for these entities cannot be retrieved as determined at step 230, the entities are excluded from being tagged within the social media environment at step 235.

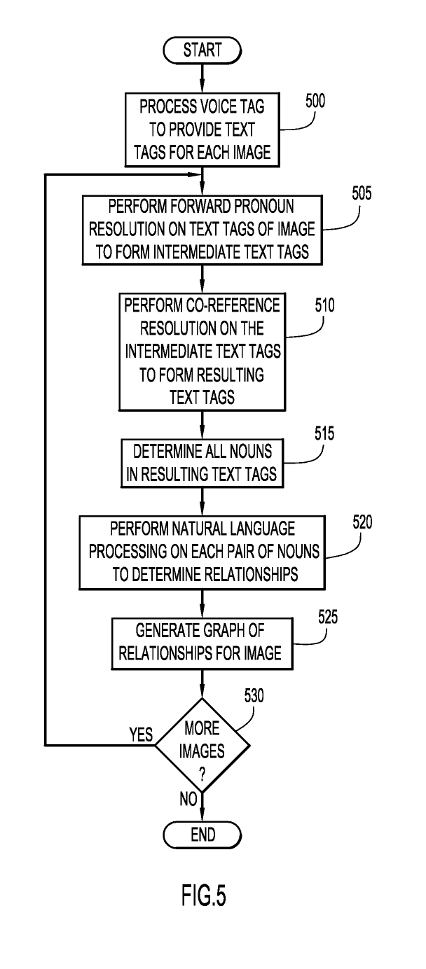

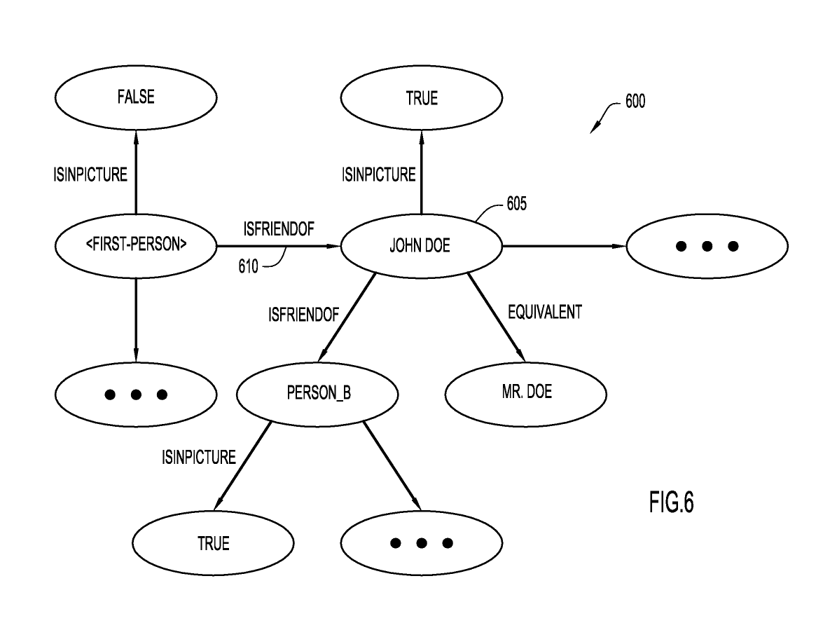

Once the sensitivity indices are determined and profiles retrieved, a graph (FIG. 6) is generated capturing relationships between entities in the voice tag at step 240. The generated graph is validated based on the friend graph or actual social networking graph of the user within the social media environment. The graph generation is further described below with respect to FIG. 5.

A set of rules are applied to identify the entities for tagging at step 245. The identified entities are automatically tagged within the social media environment. The rules may include one or more of privacy settings of the entities within the social media environment, sentiments expressed towards the entities by the user in the voice tag (from the sentiment analysis), sensitivity indices, and relationships between the entities (from the friend and relationship graphs). Example types of rules may include the following.

If the sentiment is negative, and the entity is NOT a first degree friend, disallow tagging of that entity.

If the sentiment is negative, the entity is a first degree friend, and the entity privacy settings do not allow tags, disallow tagging of the entity.

If the sentiment is negative, the entity is NOT a first degree friend, the entity privacy settings allow tagging, and the entity sensitivity index is high, disallow tagging of the entity.

If the sentiment is positive, the entity is not a first degree friend, but a friend of a first degree friend who is also present in the voice tag, and the entity privacy settings allow tagging, allow tagging of the entity.

A manner of determining a polarity or sentiment (e.g., via tag module 16 and a corresponding server system 10) for entities within a voice tag according to an embodiment of the present invention is illustrated in FIG. 3. Initially, the sentiment pertains to a user opinion concerning an entity. For example, a user takes a picture using a new smartphone, and associates the following voice tag with the picture, “My first awesome smartphone picture”. The sentiment analysis determines that the user has developed a positive opinion about the smartphone.

The sentiment analysis may be performed for one or more images, where a sentiment expressed in a voice tag may be determined across a plurality of images. In particular, the voice tags of the images are processed to provide text tags for each image at step 300. This may be accomplished by any conventional or other speech-to-text conversion techniques. The nouns of the text tags for an image are determined at step 305. This may be accomplished by a conventional or other chunk parser/tagger (e.g., Stanford POS Tagger or Stanford CoreNLP, etc.).

A set of polarities are determined with respect to each noun at step 310. A polarity basically represents the opinion of the user (e.g., a positive opinion, negative opinion or neutral opinion) with respect to an entity. This may be accomplished by invoking a conventional or other of the many available sentiment analysis tools/APIs/services for each noun. A hashmap is generated containing polarities for the nouns at step 315. The hashmap stores the polarities for the image based on keys in the foam of the corresponding nouns. Any conventional or other hash function may be utilized to determine the storage location of the polarities based on the keys.

Once a hashmap of polarities is formed for each image as determined at step 320, the hashmaps for all of the images are consolidated into a single weighted hashmap based on the hashmap keys at step 325. For example, for every instance of an entity “smartphone” across the hashmaps, counts are determined and grouped for each polarity value (e.g., “smartphone”→“positive”→“10”, “smartphone”→“negative”→“2”, “smartphone”→“neutral”→“0”, etc.). A suggested overall polarity for an entity is determined at step 330 based on these relative counts of consolidated polarities across a set of voice-tagged images and certain pre-defined thresholds (e.g., threshold counts for a polarity, polarity counts relative to one another (e.g., polarity value with greatest count is the overall polarity value, etc.), etc.). An API may be provided to third-party applications that consumes an entity and provides the following: a count for positive polarity for the entity; a count for negative polarity for the entity; a count for neutral polarity for the entity; and a suggested overall polarity.

A manner of determining a sensitivity (e.g., via tag module 16 and a corresponding server system 10) for entities within a voice tag according to an embodiment of the present invention is illustrated in FIG. 4. Initially, the sensitivity is based on a measure of popularity or notoriety of an entity as indicated by external sources. Generally, the greater the popularity or notoriety of the entity, the greater the sensitivity index and less likely the entity should be tagged within the social media environment.

The sensitivity analysis may be performed for one or more images (e.g., processing per image or in a batch type mode) to determine sensitivity indices for those images. In particular, the voice tags of the images are processed to provide text tags for each image at step 400. This may be accomplished by conventional speech-to-text conversion techniques. The text tags for an image are processed to determine information related to nouns or entities within the voice tag at step 405. This may be accomplished by employing any conventional or other techniques (e.g., Stanford CoreNLP, an open service (such as OPENCALAIS), etc.). Contextual metadata concerning the nouns or entities within the voice tag are ascertained at step 410. This may be accomplished by various conventional or other techniques (e.g., WIKI, DBPEDIA, WOLFRAM, etc.).

Once the information has been collected, a sensitivity index is assigned to each of the entities of the voice tag at step 415 based on the amount and nature of information. For example, the sensitivity index may be based on the quantity of information (e.g., the quantity of sites, articles or other information mentioning the entity, the quantity of times the entity is mentioned in the information, etc.) and a scale of values for the nature of the information (e.g., a greater value for public appearances, television, movies, etc.). These values may be combined in any fashion (e.g., added, multiplied, averaged, weighted combination, etc.). By way of example, a famous or well known entity typically enables a greater amount of information to be ascertained. The nature of the information usually includes some types of media or public events. Accordingly, this type of entity typically prefers to avoid being tagged, and the sensitivity index would be set to a greater value to bias against tagging. The sensitivity indices may be determined via any conventional or other techniques.

The above process is repeated until sensitivity indices are determined for the entities identified by the voice tag of each image as determined at step 420. The sensitivity indices may be compared to thresholds to determine a level of sensitivity (e.g., high, medium, low, etc.) for the rules applied to control tagging of the entities. The values of the sensitivity indices and thresholds may be any desired values or within any desired value ranges.

A manner of determining a relationship graph (e.g., via tag module 16 and a corresponding server system 10) according to an embodiment of the present invention is illustrated in FIG. 5. Initially, the relationship graph indicates the relationships or associations between entities within a voice tag and the user or other entities. The relationship graph includes a plurality of nodes that are interconnected with links. The nodes represent entities within the voice tag or a relationship status, while the links represent the relationship between the nodes.

For example, a user takes a group picture of graduating friends (e.g., friends B and C), and associates the following voice tag with the picture, “Graduation pic of my friends B and C”. The determination of the relationship graph understands that the picture contains friends B and C, and adds corresponding metadata describing these entities. By way of further example, a user takes a group picture of graduating friend B and B's friend C, and associates the following voice tag with the picture, “Graduation pic of my friend B and his friend C”. The determination of the relationship graph understands that the picture contains B and C, and adds metadata describing these entities and the relationship between friends B and C.

The relationship graph determination may be performed for one or more images (e.g., processing per image or in a batch type mode) to provide a relationship graph for each image. In particular, the voice tags of images are processed to provide text tags for each image at step 500. This may be accomplished by any conventional or other speech-to-text conversion techniques. Forward pronoun resolution is performed on the text tags of an image to create an intermediate set of text tags at step 505. The pronoun resolution basically replaces pronouns with their equivalent noun in the text tags to form the intermediate text tag set. For example, the following text tags, “graduation pic of my friend B and his friend C”, becomes “graduation pic of my friend B and B's friend C.” The pronoun resolution may be accomplished using any conventional or other techniques for pronoun resolution (e.g., Stanford CoreNLP, etc.).

Co-reference resolution is performed on the intermediate text tag set to create a resulting text tag set for the image set at step 510. The co-reference resolution replaces a primary reference (e.g., my, etc.) with a first-person label (e.g., representing the user providing the voice tag). In other words, the co-reference resolution basically replaces co-references with their equivalent noun in the intermediate text tag set to form the resulting text tag set. For example, the following intermediate text tags, “graduation pic of my friend B and B's friend C”, becomes “graduation pic of <first-person> friend B and B's friend C”. By way of further example, the following intermediate text tags, “graduation pic of my friend John Doe and Mr. Doe's friend C”, becomes “graduation pic of <first-person> friend John_Doe and John_Doe's friend C”. The co-reference resolution may be accomplished using any conventional or other techniques (e.g., Stanford CoreNLP, etc.).

The nouns within the resulting text tags are determined at step 515. This may be accomplished by a conventional or other chunk parser/tagger (e.g., Stanford POS Tagger or Stanford CoreNLP, etc.). Shallow or deep natural language processing (NLP) is subsequently performed on each pair of determined nouns, and intermediate relationships between the nouns are identified at step 520. This may be accomplished by various conventional machine learning algorithms that have been trained on large text corpora. Alternatively, plural binary classifiers that learn n-ary relationships between subjects may be employed to determine the relationships.

The identified relationships (e.g., <first-person>—isFriendOf—<John Doe>—isFriendOf—<C>) are utilized to generate a relationship graph from the voice tag associated with the image at step 525. The relationship graph includes metadata describing the entities that are present in the voice tag. The process is repeated until a relationship graph is generated for each image as determined at step 530.

An example relationship graph for an image is illustrated in FIG. 6. Specifically, graph 600 includes a plurality of nodes 605 that are interconnected with links 610. The nodes represent the user capturing and/or uploading the image (e.g., first-person), entities (e.g., John Doe, Mr. Doe, Person_B, etc.) within the voice tag, or a relationship status (e.g., true, false, etc.), while the links represent the relationship (e.g., IsFriendOf, equivalent, IsInPicture, etc.) between the nodes. In this case, the example graph indicates that the first-person (or user) is not present in the picture, but the first person's (or user's) friend John Doe and John Doe's friend, Person_B, are present.

It will be appreciated that the embodiments described above and illustrated in the drawings represent only a few of the many ways of implementing embodiments for applying voice tags in a social media context.

The environment of the present invention embodiments may include any number of computer or other processing systems or devices (e.g., client or end-user devices or systems, server systems, etc.), and databases or other repositories arranged in any desired fashion, where the present invention embodiments may be applied to any desired type of computing environment (e.g., cloud computing, client-server, network computing, mainframe, stand-alone systems, etc.). The client devices may be implemented by any conventional or other computer systems, or any conventional or other hand-held or mobile devices (e.g., smart or other mobile telephone, personal digital assistant, tablet, etc.) capable of capturing images and voice tags.

The computer or other processing systems employed by the present invention embodiments may be implemented by any number of any personal or other type of computer or processing system (e.g., desktop, laptop, PDA, tablets or other mobile computing devices, etc.), and may include any commercially available operating system and any combination of commercially available and custom software (e.g., browser software, communications software, server software, tag module, capture module, social media environment module, etc.). The computer systems and devices may include any types of displays or monitors and input devices (e.g., keyboard, mouse, voice recognition, touch screen, etc.) to enter and/or view information.

It is to be understood that the software (e.g., tag module, capture module, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems or devices may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client devices and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., tag module, capture module, etc.) may be available on a recordable or computer usable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any type of communications network (e.g., LAN, WAN, Internet, Intranet, VPN, etc.). The computer or other processing systems or devices of the present invention embodiments may include any conventional or other communications devices to communicate over the network via any conventional or other protocols. The computer or other processing systems or devices may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., image data, voice tags, sensitivity indices, polarity/sentiments, friend and relationship graphs, etc.). The database system may be implemented by any number of any conventional or other databases, data stores or storage structures (e.g., files, databases, data structures, data or other repositories, etc.) to store information (e.g., image data, voice tags, sensitivity indices, polarity/sentiments, friend and relationship graphs, etc.). The database system may be included within or coupled to the server and/or client systems or devices. The database systems and/or storage structures may be remote from or local to the computer or other processing systems or devices, and may store any desired data (e.g., image data, voice tags, sensitivity indices, polarity/sentiments, friend and relationship graphs, etc.).

Present invention embodiments may be utilized to tag any type of data object with any data (e.g., still image, picture, video, multimedia object, audio, etc.). The voice tags may include any voice and/or speech signals containing any desired information pertaining to an image (e.g., entities, opinions/sentiments, relationships, etc.). An image may be associated with any quantity of voice tags. The voice tags may include any desired information pertaining to any entity present or absent from the image. The entity may include any desired object (e.g., person, animal, animate or inanimate object, any item in a social network that can be associated with a voice tag, etc.). Present invention embodiments may be employed with any suitable social media or other environment employing tagging of objects.

The voice tag may be embedded within the image data for processing. Alternatively, the voice tag and image may processed as separate data sets. The data structure, VTIMAGE, may include any desired information (e.g., image, voice tag, metadata, etc.) arranged in any fashion.

The speech to text conversion, entity/noun recognition, pronoun resolution, and co-reference resolution may be accomplished via any conventional or other techniques (e.g., Stanford CoreNLP tools, etc.). The sentiment or polarities may be expressed by any quantity of any desired values, levels, or labels (e.g., positive, negative, neutral, approve, disapprove, etc.). The polarities may be stored in any suitable data structure (e.g., hashmap, array, queue, list, etc.). The hashmaps may employ any suitable hashing function (e.g., arithmetic combination of codes for letters in noun, etc.), and may be combined and weighted in any suitable fashion, where polarities from different hashmaps may be given greater or lesser weight. The overall polarity may be determined in any desired fashion from any quantity of hashmaps/images (e.g., based on any suitable thresholds for the individual polarity counts, based on polarity counts from the images relative to other polarity counts, etc.).

The graphs may include any quantity of any types of objects (e.g., nodes, links, arcs, edges, arrows, etc.) arranged in any desired fashion. The objects may represent any desired entities, connections, or relationships. The relationships may be determined based on any conventional or other techniques (e.g., learning algorithms, classifiers, etc.).

The sensitivity indices may include any desired values within any value ranges. The determination may include data from any desired local or remote sources (e.g., articles, web sites, books, magazines, journals, etc.). The sensitivity index may be determined based on any suitable combination of criteria (e.g., amount of information, nature of information, etc.). Any desired values of the sensitivity indices may be utilized to indicate a sensitivity level (e.g., a low sensitivity value may indicate a low or high sensitivity, a high sensitivity value may indicate a low or high sensitivity, etc.). Any desired thresholds may be utilized to evaluate sensitivity indices and determine sensitivity levels. The sensitivity indices may be determined, and profiles retrieved, for entities in any suitable relation with the user (e.g., any of first or greater degree friends, etc.).

The rules may be of any quantity, include any desired format, and be based on any quantity of any desired conditions (e.g., relationships, sensitivity, sentiments, privacy or other user settings or preferences, etc.). The rules may be predetermined, entered manually by a user, or generated based on various parameters or preferences (e.g., sensitivity, sentiments, user privacy or other settings, etc.).

The present invention embodiments may employ any number of any type of user interface (e.g., Graphical User Interface (GUI), command-line, prompt, etc.) for obtaining or providing information (e.g., rules, social media environment, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized to process voice tags associated with any desired object for any desired social media or other environment.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of utilizing a voice tag to automatically tag one or more entities associated with a data object within a social media environment comprising:
analyzing the voice tag to identify one or more entities recited in the voice tag, wherein the voice tag includes voice signals providing information pertaining to one or more entities associated with a data object;
determining one or more characteristics of each identified entity based on the information within the voice tag; and
determining one or more entities appropriate for tagging within the social media environment based on the one or more characteristics and user settings within the social media environment of the identified entities and automatically tagging the determined one or more entities within the social media environment.

2. The computer-implemented method of claim 1, wherein determining one or more characteristics includes:
determining a user opinion of each identified entity based on the information within the voice tag.

3. The computer-implemented method of claim 1, wherein determining the one or more characteristics includes:
determining a popularity of each identified entity based on information from external sources.

4. The computer-implemented method of claim 1, wherein determining the one or more characteristics includes:
identifying relationships between the one or more identified entities based on the information within the voice tag.

5. The computer-implemented method of claim 1, wherein determining the one or more entities appropriate for tagging includes:
applying one or more rules to the identified entities to determine the one or more entities appropriate for tagging, wherein the one or more rules include conditions based on at least one of the one or more characteristics and the user settings for the identified entities.

6. The computer-implemented method of claim 1, wherein the voice tag is embedded within data of the data object and stored with corresponding metadata in a data structure defined specifically for containing this data.

7. The computer-implemented method of claim 1, wherein the data object includes one of an image, a video, a picture, an audio recording, and a multimedia object.

8. A system for utilizing a voice tag to automatically tag one or more entities associated with a data object within a social media environment comprising:
a computer system including at least one processor configured to:
analyze the voice tag to identify one or more entities recited in the voice tag, wherein the voice tag includes voice signals providing information pertaining to one or more entities associated with a data object;
determine one or more characteristics of each identified entity based on the information within the voice tag; and
determine one or more entities appropriate for tagging within the social media environment based on the one or more characteristics and user settings within the social media environment of the identified entities and automatically tag the determined one or more entities within the social media environment.

9. The system of claim 8, wherein determining one or more characteristics includes:
determining a user opinion of each identified entity based on the information within the voice tag.

10. The system of claim 8, wherein determining the one or more characteristics includes:
determining a popularity of each identified entity based on information from external sources.

11. The system of claim 8, wherein determining the one or more characteristics includes:
identifying relationships between the one or more identified entities based on the information within the voice tag.

12. The system of claim 8, wherein determining the one or more entities appropriate for tagging includes:
applying one or more rules to the identified entities to determine the one or more entities appropriate for tagging, wherein the one or more rules include conditions based on at least one of the one or more characteristics and the user settings for the identified entities.

13. The system of claim 8, wherein the voice tag is embedded within data of the data object and stored with corresponding metadata in a data structure defined specifically for containing this data.

14. The system of claim 8, wherein the data object includes one of an image, a video, a picture, an audio recording, and a multimedia object.

15. A computer program product for utilizing a voice tag to automatically tag one or more entities associated with a data object within a social media environment comprising:
a computer readable storage medium having computer readable program code embodied therewith, the computer readable program code comprising computer readable program code configured to:
analyze the voice tag to identify one or more entities recited in the voice tag, wherein the voice tag includes voice signals providing information pertaining to one or more entities associated with a data object;
determine one or more characteristics of each identified entity based on the information within the voice tag; and
determine one or more entities appropriate for tagging within the social media environment based on the one or more characteristics and user settings within the social media environment of the identified entities and automatically tag the determined one or more entities within the social media environment.

16. The computer program product of claim 15, wherein determining one or more characteristics includes:
determining a user opinion of each identified entity based on the information within the voice tag.

17. The computer program product of claim 15, wherein determining the one or more characteristics includes:
determining a popularity of each identified entity based on information from external sources.

18. The computer program product of claim 15, wherein determining the one or more characteristics includes:
identifying relationships between the one or more identified entities based on the information within the voice tag.

19. The computer program product of claim 15, wherein determining the one or more entities appropriate for tagging includes:
applying one or more rules to the identified entities to determine the one or more entities appropriate for tagging, wherein the one or more rules include conditions based on at least one of the one or more characteristics and the user settings for the identified entities.

20. The computer program product of claim 15, wherein the voice tag is embedded within data of the data object and stored with corresponding metadata in a data structure defined specifically for containing this data.

21. The computer program product of claim 15, wherein the data object includes one of an image, a video, a picture, an audio recording, and a multimedia object.
